(19) United States
(12) Patent Application Publication
(10) Pub. No.: US 2003/0201076 A1
(43) Pub. Date: Oct. 30, 2003

(54) Venetian blind with concealed lift cords

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314

(73) Assignee: Nien Made Enterprise Co., Ltd.

(21) Appl. No.: 10/180,290

(22) Filed: Jun. 27, 2002

(30) Foreign Application Priority Data
Apr. 24, 2002 (TW) 91205589

(51) Int. Cl. E06B 9/30

(52) U.S. Cl. 160/168.1 R

(57) ABSTRACT

A Venetian blind is constructed to include a headrail, a bottom rail, a set of slats, a suspension tube downwardly extended from one end of the headrail, the suspension tube having at least one longitudinal sliding slot, at least one lift cord each having a first end fixedly fastened to the bottom rail and a second end inserted through the slats and extended through the headrail into the inside of the suspension arm, a lift cord clamp axially slidably coupled to the at least one longitudinal sliding slot of the suspension tube and adapted for press by hand to clamp the at least one lift cord, and a lift lock adapted for locking the at least one lift cords.

### BACKGROUND OF THE INVENTION

1. Field of the Invention

The present invention relates to Venetian blinds and, more specifically, to such a Venetian blind with concealed lift cords.

2. Description of the Related Art

A regular Venetian blind is generally comprised of a headrail, a bottom rail, a plurality of slats arranged in parallel between the headrail and the bottom rail, a lift control mechanism for controlling lifting and positioning of the bottom rail to adjust the extending area of the Venetian blind, and a tilting control mechanism for controlling the tiling angle of the slats to regulate the light. The lift control mechanism comprises a lift cord suspended from the headrail at one side for operation by hand to control the elevation of the bottom rail. Because the lift cord is exposed to the outside, it destroys the sense of beauty of the Venetian blind. Further, because a child can easily reach the exposed lift cord, an accident may occur when a child pulling the lift cord for fun. In order to eliminate this problem, Venetian blinds with receivable lift cord(s) are developed. Exemplars of these Venetian blinds are seen in U.S. Pat. Nos. 2,382,100; 5,531,257; 3,014,124. However, these Venetian blinds are commonly have a complicated structure and high manufacturing cost.

### SUMMARY OF THE INVENTION

It is the main object of the present invention to provide a Venetian blind, which keeps the lift cords from sight and out of reach of children.

It is another object of the present invention to provide a Venetian blind, which is orthopedically engineered for easy operation with less effort.

To achieve these objects of the present invention, the Venetian blind comprises a headrail extended in transverse direction and having a first end; a bottom rail extended in transverse direction and spaced below the headrail; a plurality of slats arranged in parallel between the headrail and the bottom rail; a suspension tube longitudinally disposed in vertical and having a top end connected to the first end of the headrail, and at least one longitudinal sliding slot; at least one lift cord each having a first end fixedly fastened to the bottom rail and a second end upwardly extended through the slats into the inside of the headrail and then transversely extended to the first end of the headrail and then extended vertically downwards from the first end of the headrail into the inside of the suspension tube; a lift cord clamp mounted in the suspension tube for movement along the at least one longitudinal sliding slot of the suspension tube and adapted for clamping the at least one lift cord, the lift cord clamp comprising a sliding sleeve sleeved onto the suspension tube, and a clamping device inserted through the at least one longitudinal sliding slot of the suspension tube and moved with the sliding sleeve up and down along the at least one sliding slot of the suspension tube and adapted for clamping the at least one lift cord; and a lift lock installed in a path in which the at least one lift cord passes and adapted for locking the at least one lift cord.

### BRIEF DESCRIPTION OF THE DRAWINGS

FIG. 1 is a schematic drawing of a Venetian blind according to the present invention, showing the blind extended out.

FIG. 2 is a sectional view in an enlarged scale of a part of FIG. 1, showing the lift cord clamp released.

FIG. 3 is a sectional view taken along line 3-3 of FIG. 2.

FIG. 4 corresponds to FIG. 2 but showing the lift cord clamp locked.

FIG. 5 is a sectional view taken along line 5-5 of FIG. 4.

FIG. 6 is a schematic drawing of the present invention, showing the operation of the lift lock.

FIG. 7 is a partial view in section of an alternate form of the Venetian blind according to the present invention.

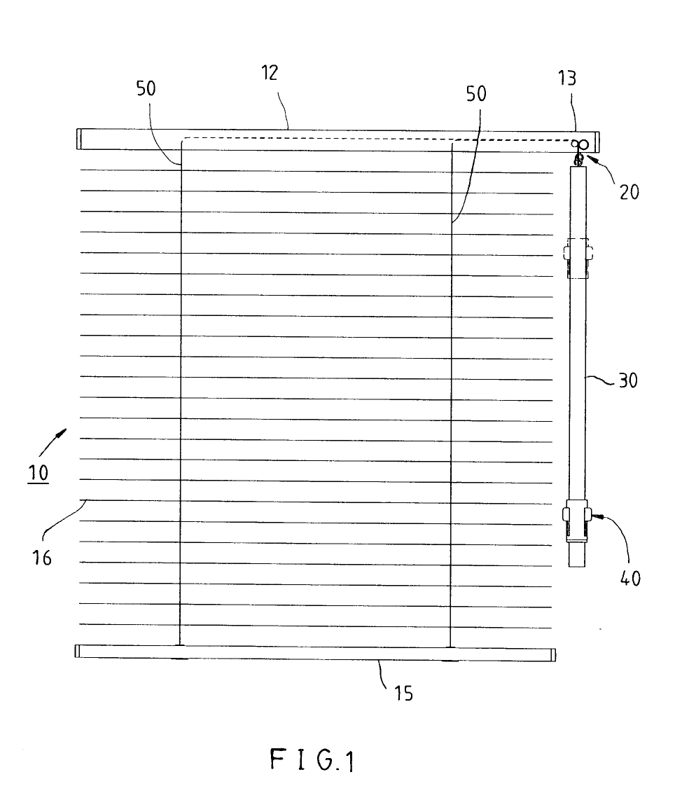

### DETAILED DESCRIPTION OF THE PREFERRED EMBODIMENT

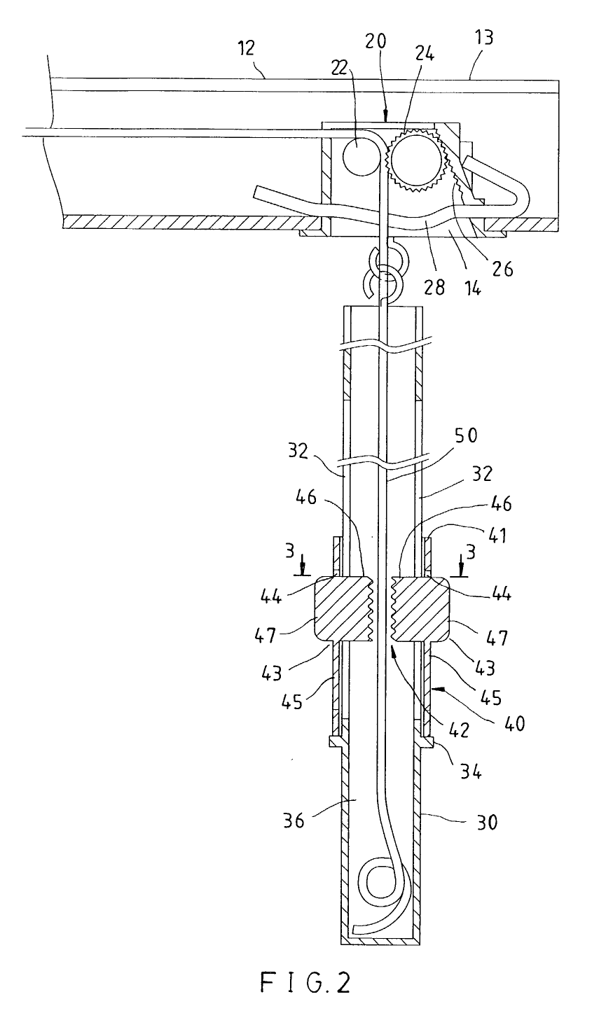

Referring to FIGS. from 1 through 3, a Venetian blind 10 is shown comprising a headrail 12 fixedly transversely fastened to the top side of the window, the headrail 12 having a first end 13 (the right end) and an opening 14 in the bottom side of the first end 13 (see FIG. 2), a bottom rail 15 extended in transverse direction and spaced below the headrail 12, a number of slats 16 arranged in parallel between the headrail 12 and the bottom rail 15, a lift lock 20 installed in the first end 13 of the headrail 12 above the opening 14, a suspension tube 30, and a lift cord clamp 40, and two lift cords 50.

The lift lock 20 is comprised of a transverse guide rod 22, an oblique rack 26, a movable ratchet wheel 24 moved with and moved along the oblique rack 26, and a stop rod 28 extended over the opening 14 below the oblique rack 26 and adapted to limit downward movement of the movable ratchet wheel 24. When the movable ratchet wheel 24 moved upwards, the movable ratchet wheel 24 is engaged into the periphery of the lift cords 50 against the guide rod 22, and therefore the lift cords 50 are locked. On the contrary, when the movable ratchet wheel 24 moved downwards, the lift cords 50 are unlocked.

The suspension tube 30 is a straight round tube having a top open end and a bottom close end. The top open end of the suspension tube 30 is pivoted to (or hung on) the bottom side of the first end 13 of the headrail 12 right below the lift cord lock 20 for deflection. The suspension tube 30 comprises two longitudinal slots 32 disposed at two sides and spaced from the top open end and bottom close end at a distance, and a stop flange 34 extended around the periphery below the bottom ends of the longitudinal slots 32. Further, the suspension tube 30 defines a receiving space 36 in the bottom of its inside (more specifically the space below the elevation of the longitudinal slots 32).

The lift cord clamp 40 comprises a sliding sleeve 41 sleeved onto the suspension tube 30 and moved up and down along the longitudinal sliding slots 32, and a clamping device 42 adapted for clamping the lift cords 50. According to this embodiment, the clamping device 42 is comprised of two spring knobs 43 symmetrically disposed at two sides. The sliding sleeve 41 comprises two openings 44 disposed at two sides corresponding to the longitudinal sliding slots 32 of the suspension tube 30. The spring knobs 43 each comprise a springy arm 45 formed integral with the peripheral wall of the sliding sleeve 41 and upwardly extended from the bottom side edge of one opening 44, an engagement block 46 inwardly protruded from the top (free) end of the springy arm 45 and a press block 47 outwardly protruded from the top (free) end of the springy arm 45. The engagement blocks 46 of the spring knobs 43 are respectively inserted through the longitudinal slots 32 into the inside of the suspension tube 30. Normally, the engagement blocks 46 are spaced from each other at a distance when the spring knobs 43 receiving no pressure. When the user press the press blocks 47 with the fingers to force the spring knobs 43 inwards, the engagement blocks 46 are forced toward each other and clamped on the lift cords 50. According to this embodiment, the engagement blocks 46 have the respective inner side serrated for engaging the periphery of the lift cords 50 positively. When the lift cord clamp 40 moved toward the bottom close end of the suspension tube 30, the stop flange 34 limits the downward movement of the lift cord clamp 40. When the lift cord clamp 40 moved upwards toward the top open end of the suspension tube 30, the spring knobs 43 will be stopped at the top ends of the longitudinal sliding slots 32 of the suspension tube 30.

The lift cords 50 have a respective first end symmetrically fixedly fastened to the bottom rail 15, and a respective second end upwardly inserted through a respective through hole (not shown) in each slat 16 and then inserted into the inside of the headrail 12 and then extended in the same direction toward the first end 13 of the headrail 12 and then extended over the transverse guide rod 22 of the lift lock 20 and then turned downwards through the gap between the transverse guide rod 22 and the movable ratchet wheel 24 to the outside of the headrail 12 via the opening 14 (the two lift cords 50 are separated by the stop rod 26 when passing through the opening 14). When extended out of the opening 14 of the headrail 12, the second ends of the lift cords 50 are inserted into the inside of the suspension tube 30, and then extended through the gap between the spring knobs 43 to the bottom side of the receiving space 36. The second ends of the lift cords 50 can be fixedly fastened to the bottom close end of the suspension tube 30 if desired. Subject to the size of the Venetian blind, the Venetian blind can be provided with one single lift cord, or more than three lift cords.

The Venetian blind 10 further comprises a tilting control mechanism adapted for controlling the tilting angle of the slats. Because the tilting control mechanism is of the known art and not within the scope of the claims of the present invention, no further detailed description in this regard is necessary.

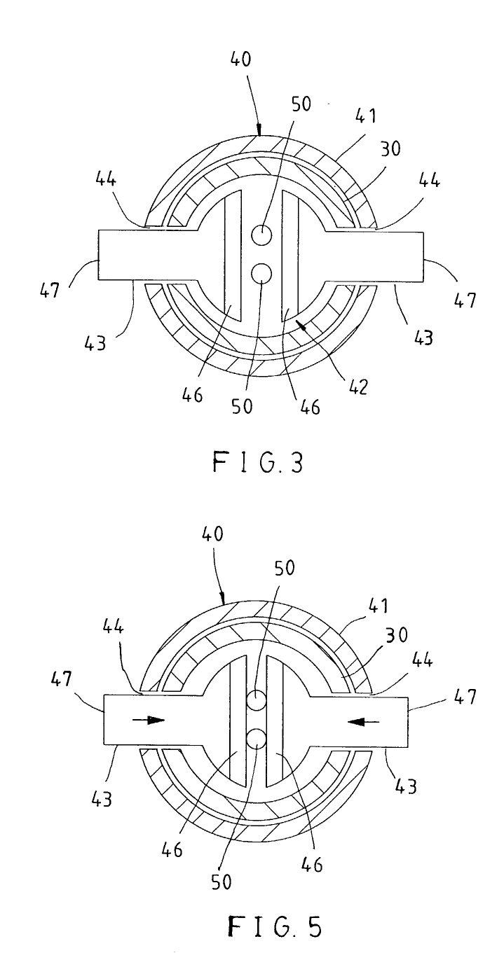

When the Venetian blind receive no external force, the lift cord clamp 40 is disposed in the lower limit position, the lift cords 50 are free from the constraint of the engagement blocks 46, as shown in FIGS. 2 and 3, and the lift lock 20 locks the lift cords 50 (see FIG. 2). The gravity weight of the bottom rail 15 and the slats 16 pulls the lift cords 50 downwards (i.e., the lift cords 50 are pulled leftwards in the headrail 12), thereby causing the movable ratchet wheel 24 to be rotated upwards along the oblique rack 26 by the lift cords 50. When the movable ratchet wheel 24 rotated upwards along the oblique rack 26, it forces the lift cords 50 against the periphery of the guide rod 22, thereby causing the lift cords 50 to be jammed in between the movable ratchet wheel 24 and the guide rod 22 to hold the bottom rail 14 at a particular elevation.

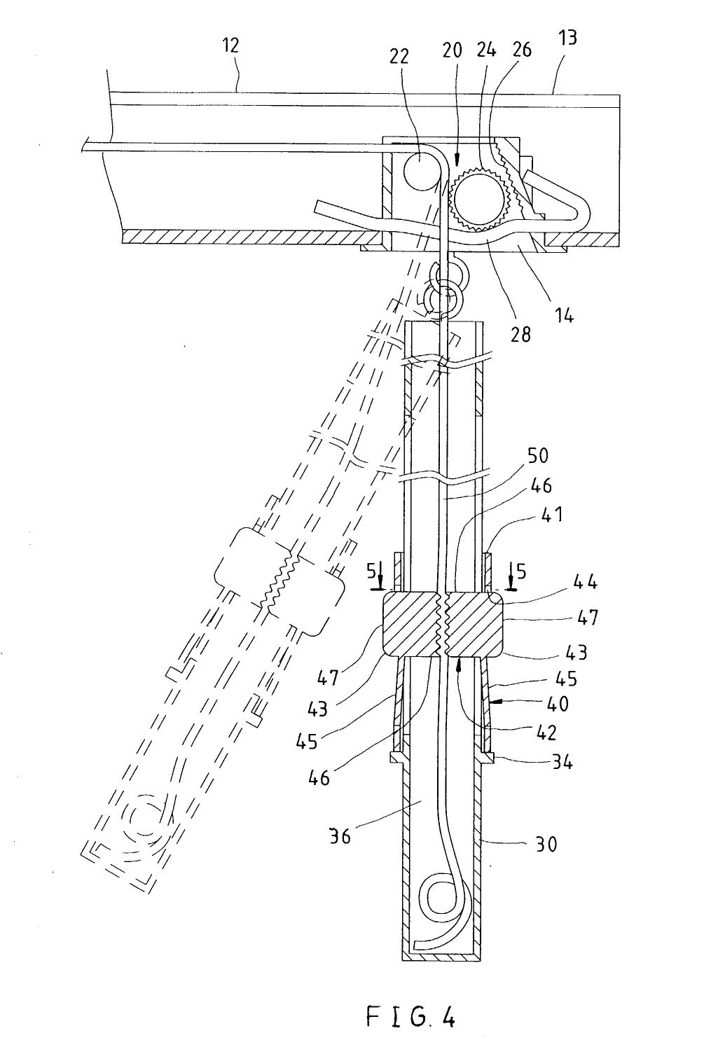

When wishing to lift the blind, the user holds the lift cord clamp 40 slightly in hand and pushes it upwards (to the upper limit position), and then squeezes the spring knobs 43 inwards with the thumb and the forefinger to force the engagement blocks 46 against the lift cords 50 at two sides, keeping the lift cords 50 secured to the spring knobs 43 (see FIGS. 4 and 5), and then turns the suspension tube 30 with the lift cords 50 to the left (see the imaginary line shown in FIG. 4) to let the movable ratchet wheel 24 move downwardly away from the engagement position for enabling the lift cords 50 to be moved back and forth relative to the lift lock 20 (after disengagement of the lift cords 50 from the movable ratchet wheel 24, the suspension tube 30 is returned to its former vertical position). At this time, the user can pull the lift cord clamp 40 with the lift cords 50 downwards relative to the suspension tube 30 to lift the bottom rail 15 and to let the lift cords 50 be accumulated in the receiving space 36.

When wishing to lower the blind, the user can directly hold the lift cord clamp 40 in the lower limit position, and then press the spring knobs 43 to clamp the lift cords 50, and then move the lift cord clamp 40 with the suspension tube 30 and the lift cords 50 to the left to release the lift cords 50 from the constraint of the lift lock 20, enabling the bottom rail 15 (and the slats 16) to pull the first ends of the lift cords 50 downwards by their gravity weight, and therefore the blind is lowered.

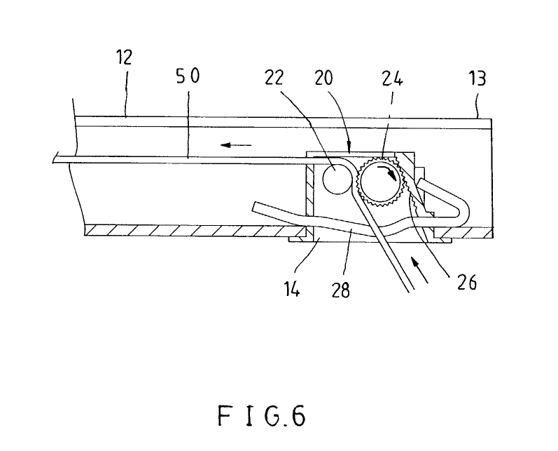

When the bottom rail 15 adjusted, either upwards or downwards, to a proper elevation, the user can keep the lift cord clamp 40 clamped on the lift cords 50 and then turn the suspension tube 30 with the lift cords 50 to the right, and then release the fingers from the spring knobs 43, at this time the bottom rail 15 and the slats 16 impart a downward pressure to the first ends of the lift cords 50 and the lift cords 50 are partially obliquely disposed in contact with the bottom side of the movable ratchet wheel 24. Therefore, when the lift cords 50 received a pulling force from the first ends, the movable ratchet wheel 24 is immediately forced to rotate in clockwise direction along the rack 26 toward the left upper end, thereby causing the lift cords 50 to be jammed in between the movable ratchet wheel 24 and the guide rod 22, as shown in FIG. 6, i.e., the bottom rail 15 is positioned at the elevation when released the lift cords 50.

Due to the factors of the size of the blind, the lengths of suspension tube 30 and longitudinal sliding slots 32, the moving distance of the sliding sleeve 40, etc., the operator may be unable to lift or lower the bottom rail 15 to the desired elevation at one time. For example, if the bottom rail 15 is not lifted to the desired elevation after the user pushed the lift cord clamp 40 to the upper limit position and clamped the lift cord clamp 40 on the lift cords 50 and then tilted the suspension tube 30 to the left to unlock the lift cords 50 and then moved the lift cord clamps 40 with the lift cords 50 to the lower limit position, the user can tilt the suspension tube 30 to the right and then release the spring knobs 43, and then move the lift cord clamp 40 to the upper limit position again, and then force the lift cord clamp 40 to clamp the lift cords 50, and then pull the lift cord clamp 40 with the lift cords 50 downwards, and the release the lift cord clamp 40 from the lift cords 50. By means of repeating the aforesaid procedure, the bottom rail 15 is lifted to the desired elevation. Similarly, the bottom rail 15 can easily be lowered to the desired elevation.

As indicated above, the user can control the lifting and positioning of the Venetian blind 10 easily (same as the operation of conventional Venetian blinds). Further, because the outer ends of the lift cords 50 that extend out of the first end 13 of the headrail 12 are received inside the suspension tube 30, the lift cords 50 are kept away from reach of children and prohibited from hooking on the arm or the neck accidentally. Another advantage of the present invention is the orthopedically engineered operation design. When lifting or lowering the blind, the user needs only to move the hand within a proper vertical range.

It is to be understood that the structure and action of the aforesaid lift lock 20 is of the known art. Various lift lock designs (the arrangement of a guide rod and an eccentrically pivoted ratchet wheel) are known and can be selectively used to substitute for the aforesaid lift lock 20.

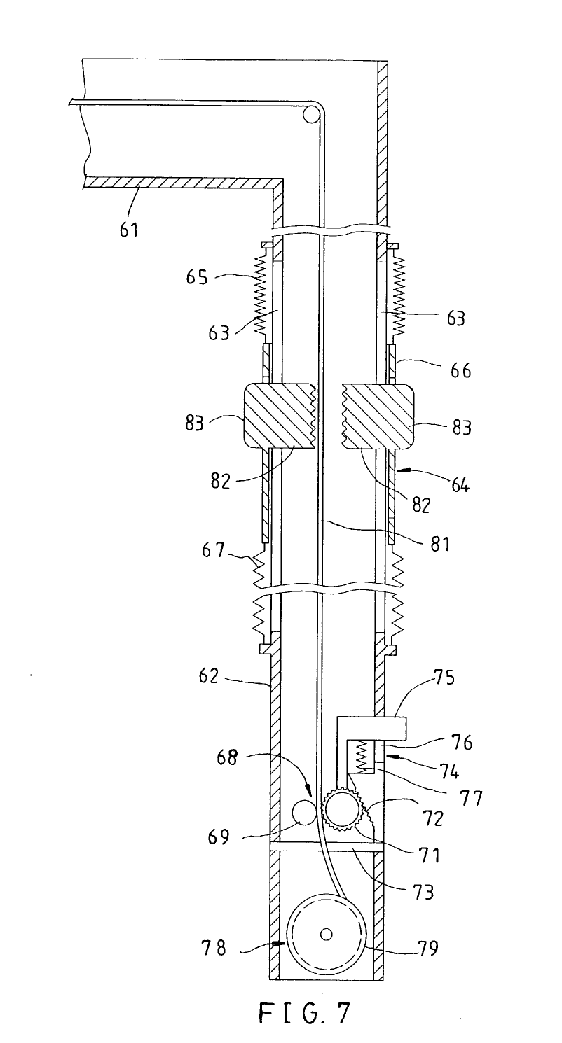

FIG. 7 shows a Venetian blind according to a second embodiment of the present invention. According to this embodiment, the lift Venetian blind comprises:

a headrail 61 (FIG. 7 shows only the first end of the headrail);

a bottom rail (not shown) spaced below the headrail 61;

a set of slats (not shown) arranged in parallel between the headrail 61 and the bottom rail;

a suspension tube 62, the suspension tube 62 being a straight round tube having a top end fixedly fastened to the first end of the headrail 61 keeping the inside space thereof in communication with the inside space of the headrail 61, the suspension tube 62 having two longitudinal sliding slots 63;

a lift cord clamp 64 installed in the suspension tube 62 (the structure of the lift cord clamp 64 and its arrangement in the suspension tube 62 are same as that of the embodiment shown in FIGS. from 1 through 6);

an upper bellows tube 65 sleeved onto the suspension tube 62, the upper bellows tube 65 having a top end fastened to the periphery of the suspension tube 62 above the longitudinal sliding slots 63 and a bottom end connected to the top edge of the sliding sleeve 66 of the lift cord clamp 64;

a lower bellows tube 67 sleeved onto the suspension tube 62, the lower bellows tube 67 having a bottom end fastened to the periphery of the suspension tube 62 below the longitudinal sliding slots 63 and a top end connected to the bottom edge of the sliding sleeve 66 of the lift cord clamp 64,

a lift lock 68 provided inside the suspension tube 62 near its bottom end below the longitudinal sliding slots 63, the lift lock 68 comprising a fixed guide rod 69, an oblique rack 72, a movable ratchet wheel 71 meshed with and moved along the oblique rack 72, and a stop rod 73 provided below the oblique rack 72 and adapted to limit downward movement of the movable ratchet wheel 71;

a release 74 installed in the suspension tube 62 above the lift lock 68, the release 74 comprising an angled knob 75 extended through a through hole 76 in the suspension tube 62 and aimed at the movable ratchet wheel 71 of the lift lock 68, and a spring 77 provided inside the suspension tube 62 and supporting the angled knob 75 in the upper limit position at the top side of the through hole 76;

a rolling mechanism 78 mounted inside the suspension tube 62 at the bottom, the rolling mechanism 78 comprising a reel 79 pivoted to the inside of the suspension tube 62 for free rotation, a torsional spring (not shown) connected between the reel 79 and the suspension tube 62 and impart a rotary force to the reel 79 in one direction; and

two lift cords 81, the lift cords 81 each having a first end fixedly fastened to the bottom rail, and a second end inserted through the slats into the inside of the headrail and ten extended sideways to the first end of the headrail and then turned downwards into the inside of the suspension tube 62 and then extended through the gap between the engagement blocks 82 of the spring knobs 83 of the lift cord clamp 64 and the gap between the guide rod 69 and the movable ratchet wheel 71 and then fixedly fastened to the periphery of the reel 79 of the winding mechanism 78.

The operation of this second embodiment is outlined hereinafter. When received no external force, the lift cords 81 is locked by the lift lock 68, holding the bottom rail of the blind at a predetermined elevation. When lifting the blind, move the lift cord clamp 64 to a higher place, and then squeeze the spring knobs 83 of the lift cord clamp 64 to clamp the lift cords 81.When pulling the lift cord clamp 64 with the lift cords 81 slightly downwards to conquer the pulling force of the bottom rail and the slats at this time, the movable ratchet wheel 71 is disengaged from the lift cords 81, for enabling the lift cords 81 to be moved relative to the lift lock 68. Thus, pulling the lift cord clamp 64 with the lift cords 81 downwards causes the lift cords 81 to be pulled toward the bottom side of the suspension tube 62, enabling the reel 79 of the winding mechanism 78 to be forced by the torsional spring to wind up the lift cords 81. When winding up the lift cords 81, the lift cords 81 move the movable ratchet wheel 71 of the lift lock 68 toward the bottom side, and therefore the movable ratchet wheel 71 does not lock the lift cords 81 at this time.

When released the fingers from the spring knobs 83 of the lift clamp 64, the lift cords 81 are pulled slightly upwards by the pulling force from the bottom rail, thereby causing the movable ratchet wheel 71 of the lift lock 68 to be rotated upwards to lock the lift cords 81.

When lowering the blind, directly pres the angled knob 75 of the release 74 to force the movable ratchet wheel 71 of the lift lock 68 downwards and to release the lift cords 81 from the constraint of the movable ratchet wheel 71, enabling the bottom rail and the slats to move downwards by their gravity weight. When the bottom rail moved to the desired elevation, release the angled knob 75, enabling the movable ratchet wheel 71 to be forced upwards by the lift cords 81 to lock the lift cords 81 again. Before lowering the blind, the user can operate the lift cord clamp 64 to clamp the lift cords 81 and the press the angled knob 75 to disengage the movable ratchet wheel 71 from the lift cords 81, and then hold the lift cord clamp 64, for enabling the lift cord clamp 64 to be moved with the lift cords 81 upwards subject to the downward force of the bottom rail and the slats.

In case the bottom rail cannot be lifted or lowered to the desired elevation at one stroke, the aforesaid repeat operation technique is employed to repeatedly move the lift cord clamp 64, force the lift cord clamp 64 to clamp the lift cords 81, and release the lift cord clamp 64 from the lift cords 81.

What is claimed is:

1. A Venetian blind comprising:
a headrail extended in transverse direction, said headrail having a first end;
a bottom rail extended in transverse direction and spaced below said headrail;
a plurality of slats arranged in parallel between said headrail and said bottom rail;
a suspension tube longitudinally disposed in vertical, said suspension tube having a top end connected to the first end of said headrail, said suspension tube comprising at least one longitudinal sliding slot;
at least one lift cord, said at least one lift cord each having a first end fixedly fastened to said bottom rail and a second end upwardly extended through said slats into the inside of said headrail and then transversely extended to the first end of said headrail and then extended vertically downwards from the first end of said headrail into the inside of said suspension tube;
a lift cord clamp mounted in said suspension tube for movement along said at least one longitudinal sliding slot of said suspension tube and adapted for clamping said at least one lift cord, said lift cord clamp comprising a sliding sleeve sleeved onto said suspension tube, and a clamping device inserted through said at least one longitudinal sliding slot of said suspension tube and moved with said sliding sleeve up and down along said at least one sliding slot of said suspension tube and adapted for clamping said at least one lift cord; and
a lift lock installed in a path in which said at least one lift cord passes and adapted for locking said at least one lift cord.

2. The Venetian blind as claimed in claim 1, wherein the top end of said suspension tube is pivoted to the first end of said headrail; said lift lock is mounted inside the first end of said headrail.

3. The Venetian blind as claimed in claim 2, wherein said lift lock comprises a fixed guide rod adapted for guiding said at least one lift cord toward said suspension tube, a fixed oblique rack spaced from said fixed guide rod at one side, and a movable ratchet wheel meshed with said oblique rack and moved along said oblique rack between two ends of said oblique rack to lock/unlock said at least one lift cord.

4. The Venetian blind as claimed in claim 1, wherein the top end of said suspension tube is fixedly fastened to the first end of said headrail; said lift lock is mounted inside said suspension arm below said lift cord clamp.

5. The Venetian blind as claimed in claim 4, wherein said lift lock comprises a fixed guide rod adapted for guiding said at least one lift cord downward, a fixed oblique rack spaced from said guide rod at one side, and a movable ratchet wheel meshed with and moved along said oblique rack between two ends of said oblique rack to lock/unlock said at least one lift cord; said suspension tube comprises a through hole corresponding to said lift lock; a release is installed in the through hole of said suspension tube and adapted to disengage said movable ratchet wheel from said at least one lift cord, said release comprising a spring provided inside said suspension tube and a knob supported on said spring above said movable ratchet wheel and partially extended out of said through hole of said suspension tube for pressing by the user to disengage said movable ratchet wheel from said at least one lift cords.

6. The Venetian blind as claimed in claim 1, wherein said suspension arm comprises two longitudinal sliding slots symmetrically disposed at two sides; said sliding sleeve of said lift cord clamp comprises two openings disposed at two sides corresponding to the longitudinal sliding slots of said suspension tube; said clamping device of said lift cord clamp comprises two spring knobs symmetrically disposed at two sides and adapted for oppressing by hand to clamp said at least one lift cord.

7. The Venetian blind as claimed in claim 6, wherein said spring knobs each comprise a springy arm formed integral with the peripheral of said sliding sleeve and respectively upwardly extended from a respective bottom side edge of each of the openings of said sliding sleeve, said springy arm having a fixed end connected to said suspension tube and a free end, an engagement block inwardly protruded from the free end of said springy arm and respectively inserted through the longitudinal sliding slots of said suspension tube into the inside of said suspension tube, and a press block outwardly protruded from the free end of said springy arm and disposed outside said sliding sleeve.

8. The Venetian blind as claimed in claim 1, wherein said suspension tube comprises a winding mechanism disposed on the inside near a bottom side thereof and adapted for winding up said at least one lift cord.

9. The Venetian blind as claimed in claim 8, wherein said winding mechanism comprises a reel pivoted to the inside of said suspension tube, and a torsional spring connected between said suspension tube and said reel and imparting a rotary force to said reel; the second end of each of said at least one lift cord is respectively fastened to the periphery of said reel.

10. The Venetian blind as claimed in claim 1 further comprising an upper bellows tube sleeved onto said suspension tube, said upper bellows tube having a top end fastened to the periphery of said suspension tube above said at least one longitudinal sliding slot and a bottom end connected to a top edge of said sliding sleeve of said lift cord clamp, and a lower bellows tube sleeved onto said suspension tube, said lower bellows tube having a bottom end fastened to the periphery of said suspension tube below said at least one longitudinal sliding slot and a top end connected to a bottom edge of said sliding sleeve of said lift cord clamp.
